(19) United States
(12) Patent Application Publication
(10) Pub. No.: US 2022/0168869 A1
(43) Pub. Date: Jun. 2, 2022

(54) SCREWDRIVING TOOL

(71) Applicant: MAKITA CORPORATION, Anjo-shi (JP)

(72) Inventors: Shogo TOMINAGA, Anjo-shi (JP); Manabu SUGIMOTO, Anjo-shi (JP); Yuji SAKAKIBARA, Anjo-shi (JP)

(73) Assignee: MAKITA CORPORATION, Anjo-shi (JP)

(21) Appl. No.: 17/504,109

(22) Filed: Oct. 18, 2021

(30) Foreign Application Priority Data
Dec. 2, 2020 (JP) 2020-200489

(51) Int. Cl. B25B 21/00; B25F 5/00

(52) U.S. Cl. CPC B25B 21/002; B25F 5/001

(57) ABSTRACT

A screwdriver compact in a front-rear direction includes a motor including a stator and a rotor including a rotor shaft extending upward frontward, a switch, a pinion, a clutch operable with the pinion, a bit holder movable in the front-rear direction in front of the clutch, a gear housing accommodating the pinion and the clutch and including front and rear divided parts, a motor housing joined to the gear housing and accommodating the motor, and a resin grip joined to the motor housing and accommodating the switch. The bit holder at a rearward position causes the clutch to be connecting to transmit rotation of the rotor and at a frontward position causes the clutch to be disconnecting to transmit no rotation of the rotor.

### CROSS-REFERENCE TO RELATED APPLICATIONS

This application claims the benefit of priority to Japanese Patent Application No. 2020-200489, filed on Dec. 2, 2020, the entire contents of which are hereby incorporated by reference.

### BACKGROUND

### 1. Technical Field

The present disclosure relates to a screwdriving tool (a screwdriver for a drywall or a board) for tightening screws into drywalls.

### 2. Description of the Background

Japanese Unexamined Patent Application Publication No. 2015-58517 (Patent Literature 1) describes a screwdriving tool including a motor, a clutch, and a bit holder (spindle). The clutch is located in front of the motor. The bit holder is in front of the clutch and is movable in the front-rear direction. The bit holder is urged to a frontward position at which the clutch is not in operation (disconnecting). As the bit holder retracts, the rotation of the motor is transmitted to the spindle through the clutch. This allows the bit to tighten a screw into a drywall.

### BRIEF SUMMARY

The motor described in Patent Literature 1 includes a rotation shaft with a pinion facing frontward. The motor thus has a longer overall length in the front-rear direction and cannot be more compact. A screwdriving tool is to be improved while being made more compact.

One or more aspects of the present disclosure are directed to a screwdriving tool that is compact in the front-rear direction and includes a gear positioned with predetermined accuracy.

One or more aspects of the present disclosure are also directed to a screwdriving tool that is compact in the front-rear direction and includes a gear housing with improved sealing performance.

A first aspect of the present disclosure provides a screwdriving tool, including:
a motor including a stator and a rotor, the rotor being rotatable relative to the stator and including a rotor shaft extending vertically;
a switch operable to rotate the rotor;
a pinion rotatable by the rotor shaft;
a clutch configured to transmit rotation from the pinion;
a bit holder located in front of the clutch, the bit holder being movable in a front-rear direction, the bit holder being at a rearward position to cause the clutch to be connecting to transmit the rotation of the rotor, the bit holder being at a frontward position to cause the clutch to be disconnecting to transmit no rotation of the rotor;
a gear housing accommodating the pinion and the clutch, the gear housing at least partly comprising metal;
a motor housing joined to the gear housing and accommodating the motor, the motor housing comprising resin; and
a grip joined to the motor housing and accommodating the switch, the grip comprising resin.

A second aspect of the present disclosure provides a screwdriving tool, including:
a motor including a stator and a rotor, the rotor being rotatable relative to the stator and including a rotor shaft extending at least vertically;
a switch operable to rotate the rotor;
a pinion rotatable by the rotor shaft;
a clutch configured to transmit rotation from the pinion;
a bit holder located in front of the clutch, the bit holder being movable in a front-rear direction, the bit holder being at a rearward position to cause the clutch to be connecting to transmit rotation of the rotor, the bit holder being at a frontward position to cause the clutch to be disconnecting to transmit no rotation of the rotor;
a gear housing accommodating the pinion and the clutch, the gear housing including two divided parts in the front-rear direction;
a motor housing joined to the gear housing and accommodating the motor; and
a grip joined to the motor housing and accommodating the switch, the grip comprising resin.

The screwdriving tool according to the first aspect has a shorter overall length in the front-rear direction and can be compact. A gear can be positioned with predetermined accuracy.

The screwdriving tool according to the second aspect has a shorter overall length in the front-rear direction and can be compact. The gear housing includes two divided parts in the front-rear direction and thus has improved sealing performance.

### BRIEF DESCRIPTION OF DRAWINGS

FIG. 1 is a perspective view of an autofeed screwdriver.

FIG. 2 is a side view of the autofeed screwdriver.

FIG. 3 is a plan view of the autofeed screwdriver.

FIG. 4 is a cross-sectional view taken along line A-A in FIG. 3.

FIG. 5 is an exploded perspective view of a gear housing and a clutch.

FIG. 6 is a perspective view of a body housing without showing a left half housing and a motor.

FIG. 7 is an exploded perspective view of a switch plate assembly.

FIG. 8 is an enlarged cross-sectional view taken along line B-B in FIG. 3.

### DETAILED DESCRIPTION

Embodiments of the present disclosure will now be described with reference to the drawings.

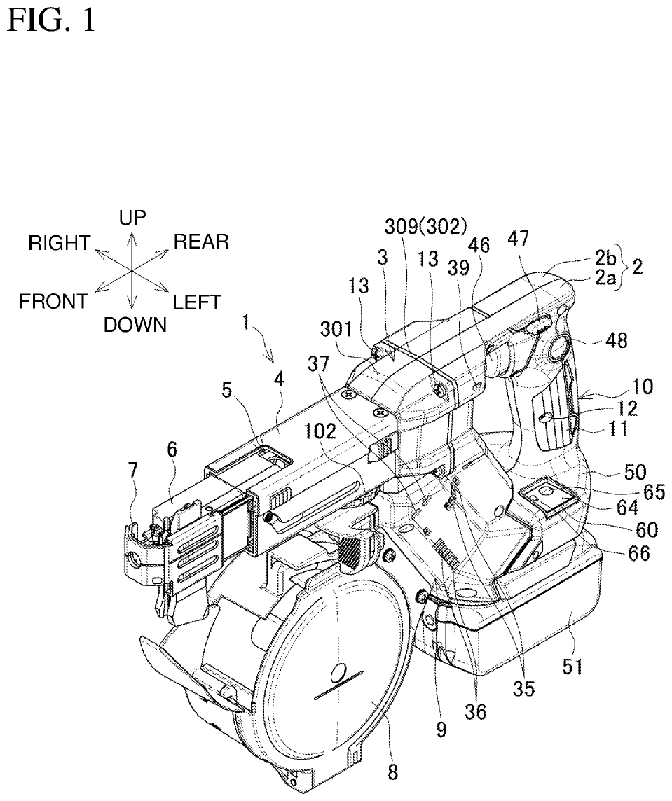

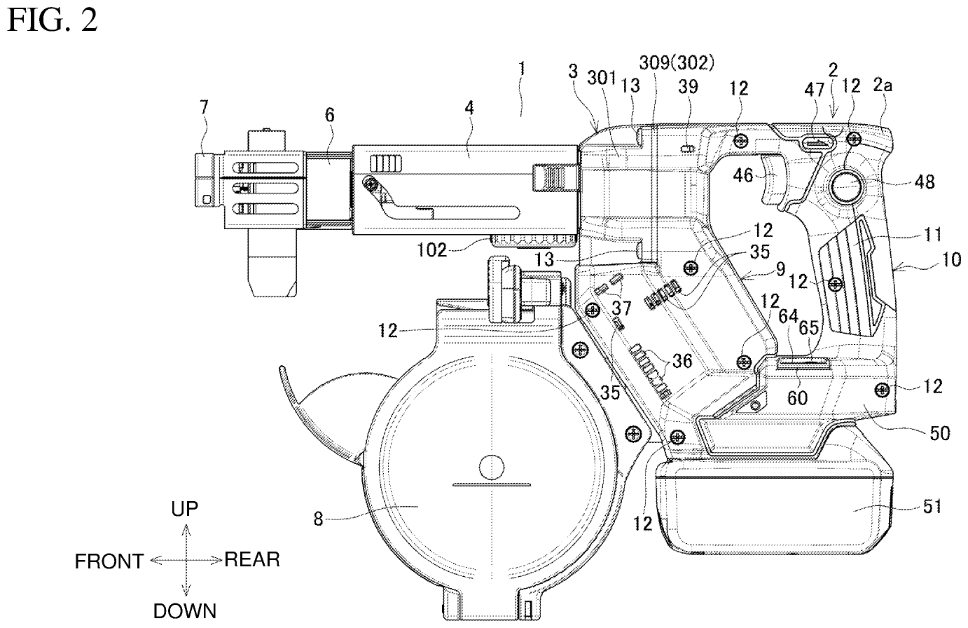

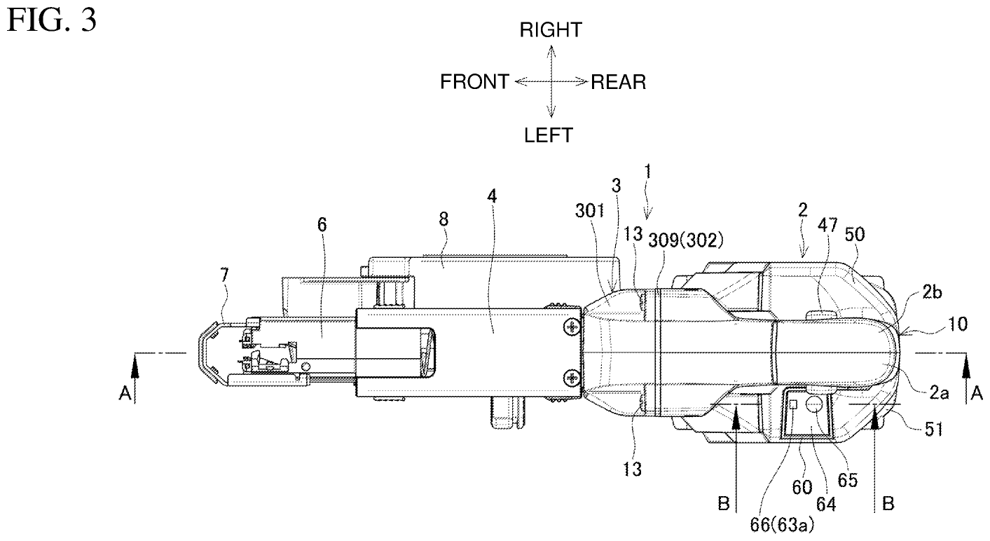

FIG. 1 is a perspective view of an autofeed screwdriver as an example of a screwdriving tool (a screwdriver for a drywall or a board). FIG. 2 is a side view of the autofeed screwdriver. FIG. 3 is a plan view of the autofeed screwdriver.

An autofeed screwdriver (hereafter simply a screwdriver) 1 includes a body housing 2, a cylindrical gear housing 3, a cylindrical casing 4, a clutch 5, a feeder box 6, a stopper base 7, and a magazine 8.

The gear housing 3 is joined to the front of the body housing 2. The casing 4 is joined to the front of the gear housing 3 to extend frontward. The clutch 5 is inside the gear housing 3 and the casing 4. The feeder box 6 is in front of the casing 4. The stopper base 7 is at the front end of the feeder box 6. The magazine 8 accommodates collated screws. The magazine 8 is below the casing 4 and in front of the body housing 2.

The body housing 2 is formed from resin. The body housing 2 includes a motor housing 9 and a grip housing 10 that are integral with each other. The motor housing 9 has an upper end connected to the gear housing 3. The motor housing 9 extends linearly and diagonally with its lower end located more rearward than its upper end. The grip housing 10 is in a loop and has its upper and lower ends connected to the rear of the motor housing 9. The grip housing 10 includes a grip 11 extending vertically.

The body housing 2 includes a pair of left and right half housings 2a and 2b that are joined together with multiple screws 12 placed from the left. The gear housing 3 is joined to the upper front of the body housing 2 with four screws 13 placed from the front.

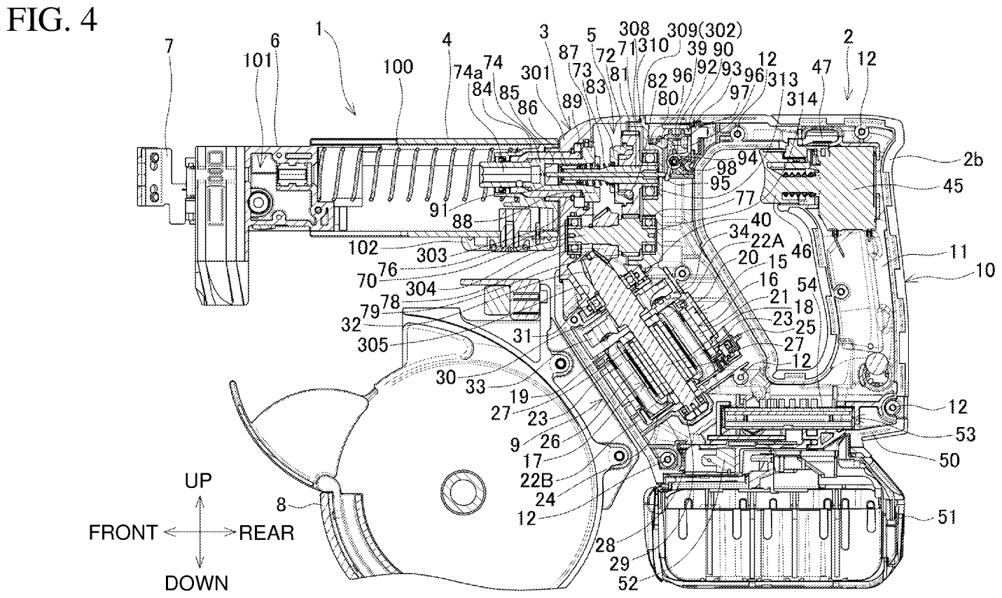

As shown in FIG. 4, the motor housing 9 accommodates a motor 15. The motor 15 is a brushless inner-rotor motor. The motor 15 includes a cylindrical stator 16 and a rotor 17. The rotor 17 is located inside the stator 16. The rotor 17 includes a rotational shaft 18. The motor 15 is supported in the motor housing 9 with the rotational shaft 18 extending diagonally upward along the motor housing 9.

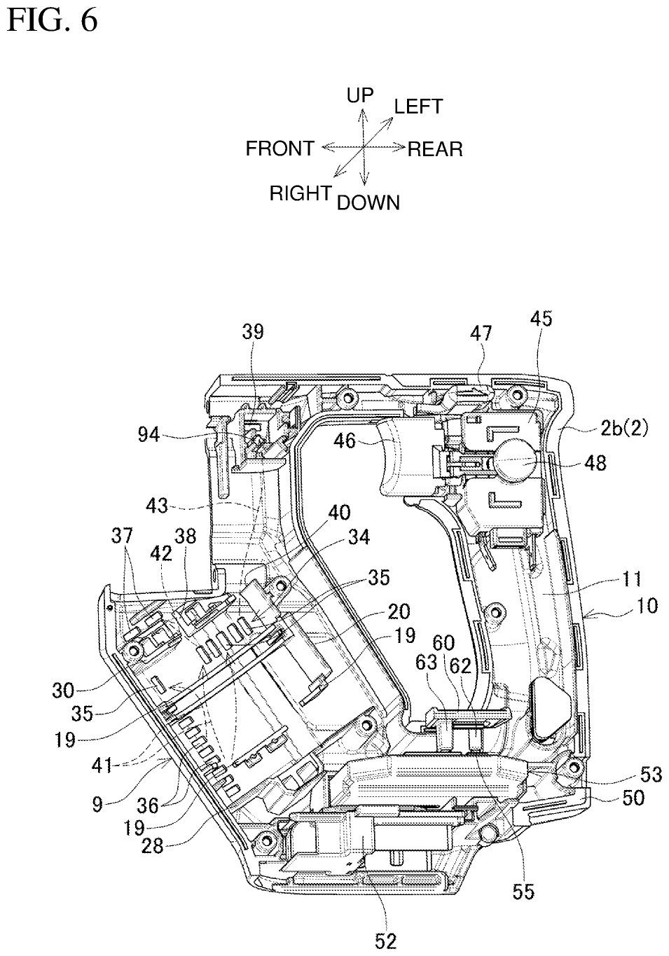

The motor 15 is adjacent to the inner front surface of the motor housing 9. As shown in FIG. 6, the motor housing 9 includes support ribs 19 extending upright from the inner surface of the motor housing 9. The support ribs 19 support the stator 16 at a frontward position. The motor housing 9 includes, above and rearward from the stator 16, a side wall 20 extending upright from the inner surface of the motor housing 9. The side wall 20 connects with support ribs 19 and extends parallel to the rotational shaft 18.

The stator 16 includes a stator core 21, an upper insulator 22A, a lower insulator 22B, and multiple coils 23. A sensor circuit board 24 is fastened with screws to the lower insulator 22B from below. The sensor circuit board 24 includes a rotation detecting element (not shown) on the upper surface. The rotation detecting element detects the magnetic field of multiple permanent magnets 27 included in the rotor 17. The wire of each coil 23 forms a three-phase connection. The power line for the three-phase connection extends from behind the insulator 22B through a connector 25 to a controller 53 (described later). The signal wire from the rotation detecting element also extends from behind the sensor circuit board 24 to the controller 53.

The rotor 17 includes the rotational shaft 18 and a rotor core 26. The rotor core 26 surrounds the rotational shaft 18. The permanent magnets 27 are fixed inside the rotor core 26.

The motor housing 9 includes a lower wall 28 extending upright from its inner surface. The rotational shaft 18 has a lower end supported on the lower wall 28 in a rotatable manner with a bearing 29 in between. The lower wall 28 is spaced from the lower end of the side wall 20. The connector 25 protrudes into the motor housing 9 from between the lower wall 28 and the side wall 20.
The motor housing 9 includes an upper wall 30 extending upright from its inner surface. The rotational shaft 18 has an upper portion protruding upward from the upper wall 30 and supported by a bearing 31 in a rotatable manner. The bearing 31 is held in the gear housing 3. The rotational shaft 18 receives a pinion 32 on its upper end. The upper end of the rotational shaft 18 protrudes into the gear housing 3.

The rotational shaft 18 receives a fan 33 between the stator 16 and the bearing 31. The fan 33 is a centrifugal fan. The fan 33 is accommodated in a fan compartment 34 surrounded by the upper support rib 19, the side wall 20, and the upper wall 30.

The motor housing 9 has multiple lower outlets 35 in each of its lateral side surfaces outward from the fan 33. The lower outlets 35 are aligned diagonally downward forward and are orthogonal to the rotational shaft 18. Below the fan 33, the motor housing 9 has multiple inlets 36 in each of its lateral side surfaces. The inlets 36 are aligned along the axis of the rotational shaft 18. The inlets 36 have a total opening area less than the total opening area of the lower outlets 35.

Above the upper wall 30, the motor housing 9 has two intermediate outlets 37 in each of its lateral side surfaces. The upper wall 30 has a slit 38 (FIG. 6). The slit 38 connects the space above the upper wall 30 on the right and left of the bearing 29 to the fan compartment 34.

Behind the gear housing 3, the body housing 2 has an upper outlet 39 in each of its lateral side surfaces. The side wall 20 and the upper wall 30 are separated by a clearance 40. The clearance 40 connects the space behind the gear housing 3 to the fan compartment 34.

The body housing 2 thus has a first cooling channel 41 as shown in FIG. 6. As the fan 33 rotates, the first cooling channel 41 allows the outside air drawn in through the inlets 36 to flow upward in the motor housing 9 to the fan compartment 34 and be discharged through the lower outlets 35.

The body housing 2 also has a second cooling channel 42. The second cooling channel 42 allows a portion of the air undischarged through the lower outlets 35 to flow upward through the slit 38 and be discharged through the intermediate outlets 37.

The body housing 2 also has a third cooling channel 43. The third cooling channel 43 allows another portion of the air undischarged through the lower outlets 35 to flow upward through the clearance 40 and be discharged through the upper outlets 39.

The grip 11 accommodates a switch 45 in its upper portion. A trigger 46 protrudes frontward from the switch 45. A forward-reverse switch lever 47 is located above the switch 45. A forward-reverse lever switch (not shown) is located between the switch 45 and the forward-reverse switch lever 47. The forward-reverse lever switch performs a switching operation in response to an operation on the forward-reverse switch lever 47. A lock button 48 is located below the forward-reverse switch lever 47 to lock the trigger 46 at a depressed position.

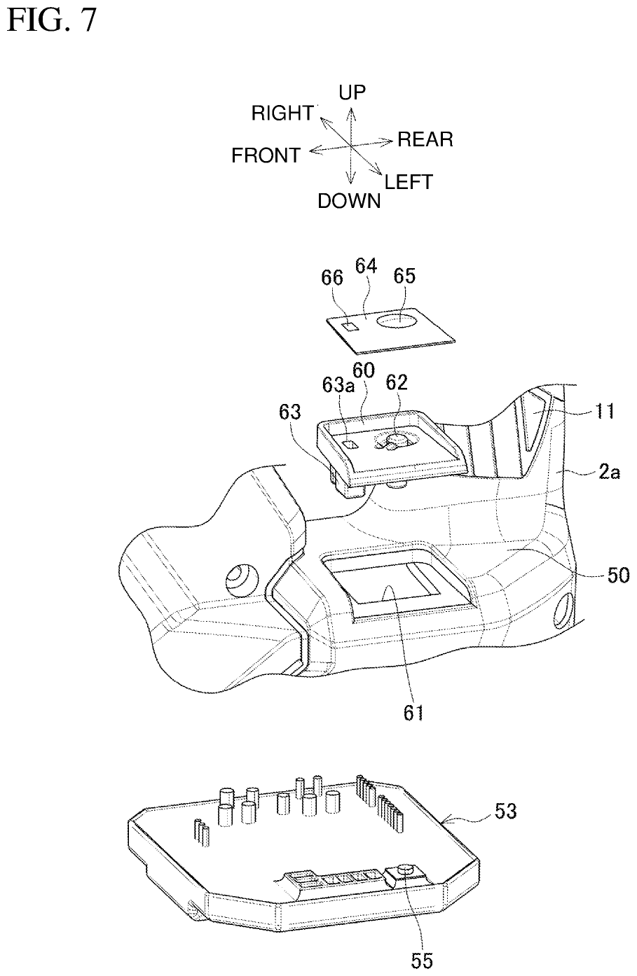

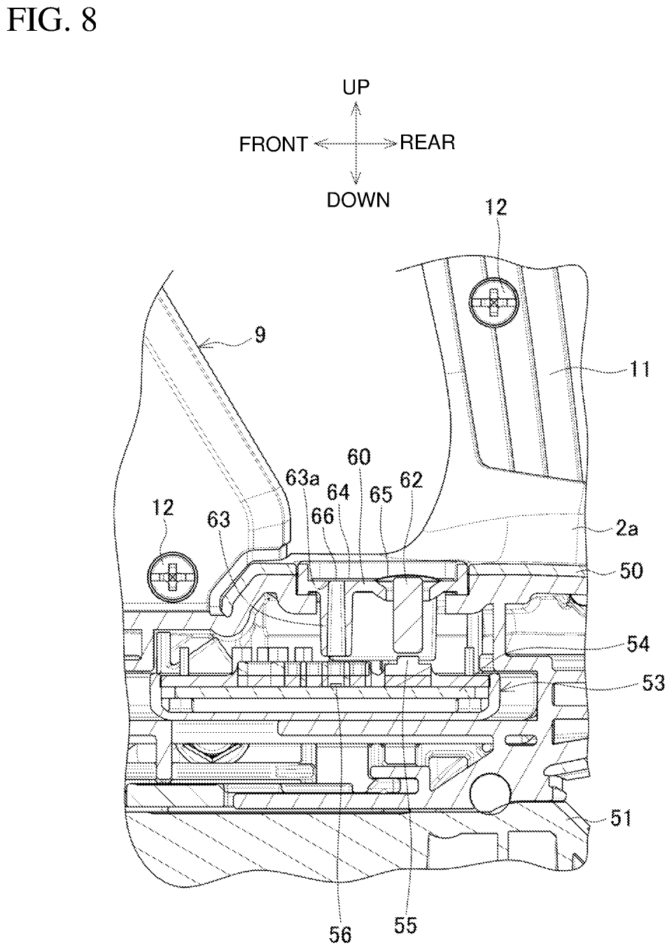

A battery mount 50 is located below the grip housing 10 to receive a battery pack 51 in a manner slidable from the rear. The battery mount 50 receives a terminal block 52. The terminal block 52 is electrically connectable to the battery pack 51. The battery mount 50 also receives a controller 53 above the terminal block 52. The controller 53 includes a control circuit board 54. As shown in FIGS. 7 and 8, the control circuit board 54 includes, in addition to a microcomputer and switching elements, a button switch 55 for mode switching and a light-emitting diode (LED) 56 for mode switching indication. The button switch 55 and the LED 56 are located at the left edge of the control circuit board 54.

The half housing 2a accommodates a switch plate 60 above and in a left area of the control circuit board 54. The switch plate 60 is rectangular as viewed in plan. The switch plate 60 is fitted in a rectangular hole 61 (as viewed in plan) in the upper left surface of the battery mount 50. The switch plate 60 is integral with an operation rod 62. The operation rod 62 moves downward as depressed from above. As shown in FIG. 7, the operation rod 62 is immediately above the button switch 55.

In front of the operation rod 62, the switch plate 60 has a hollow rectangular prism 63 extending downward. The hollow rectangular prism 63 is integral with the switch plate 60. The hollow rectangular prism 63 is immediately above the LED 56. The hollow rectangular prism 63 has a through-hole defining an opening 63a in the upper surface of the switch plate 60.

The switch plate 60 receives an indicator sheet 64 adhering to the upper surface of the switch plate 60. The indicator sheet 64 includes a button indicator 65 and a transparent illuminating portion 66. The button indicator 65 covers the upper surface of the operation rod 62. The illuminating portion 66 covers the opening 63a of the hollow rectangular prism 63.

As shown in FIG. 4, the clutch 5 includes, inside the gear housing 3, a countershaft 70, a first spindle 71, a clutch cam 72, a coil spring 73, and a second spindle 74.

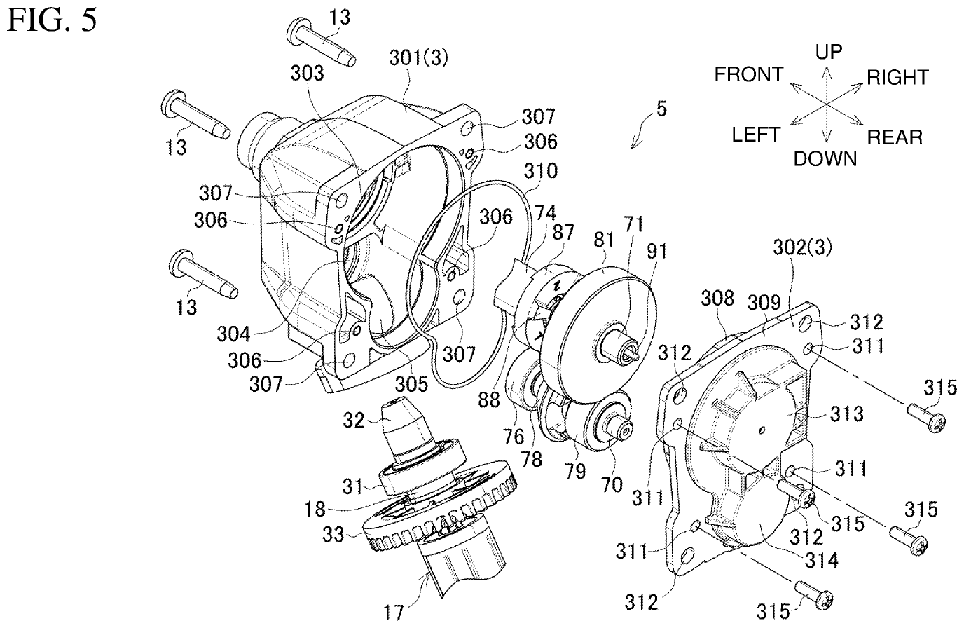

As shown in FIG. 5, the gear housing 3 includes a front gear housing 301 and a rear gear housing 302. The front gear housing 301 is a quadrangular box (in a front view) having an opening in the rear surface. The front gear housing 301 is formed from metal such as an aluminum alloy. The front gear housing 301 has an upper through-hole 303 extending in the front-rear direction in its upper front portion. The front gear housing 301 includes a front bearing holder 304 recessed in its lower front portion. The front gear housing 301 has a lower through-hole 305 extending diagonally downward rearward in its lower portion. The front gear housing 301 has the lower portion protruding into the motor housing 9 and held on the upper wall 30. The front gear housing 301 has four threaded holes 306 around the opening in the rear surface. The front gear housing 301 has four front holes 307 receiving the screws 13 in its four corners.

The rear gear housing 302 is formed from resin. The rear gear housing 302 is a plate covering the rear surface of the front gear housing 301. The rear gear housing 302 includes a peripheral wall 308 in its front surface. The peripheral wall 308 is fitted into the opening in the front gear housing 301 from the rear. A flange 309 is located outside the peripheral wall 308. The flange 309 is in contact with the rear surface of the front gear housing 301. A seal ring 310 is held between the rear surface of the front gear housing 301 and the flange 309. The seal ring 310 surrounds the peripheral wall 308. The seal ring 310 is fitted into a groove on the front surface of the flange 309 around the peripheral wall 308. This positions the seal ring 310. The flange 309 has four through-holes 311 outside the seal ring 310. The four through-holes 311 are aligned with the threaded holes 306 in the front gear housing 301. The flange 309 has four rear holes 312 in its four corners. The four rear holes 312 are aligned with the front holes 307.

The rear gear housing 302 includes, on its front surface and inside the peripheral wall 308, rear bearing holders 313 and 314 arranged vertically.

The rear gear housing 302 receives the clutch 5. The rear gear housing 302 is joined to the front gear housing 301 with the peripheral wall 308 fitted into the opening in the front gear housing 301 with the seal ring 310 in between. The seal ring 310 is positioned in the groove on the flange 309. The seal ring 310 is compressed upon coming into contact with the rear surface of the front gear housing 301. With the seal ring 310 being compressed, four screws 315 are placed through the through-holes 311 and threaded into the threaded holes 306 from the rear. This fixes the rear gear housing 302 to the front gear housing 301. The joined gear housing 3 is mounted onto the body housing 2 with the screws 13 placed through the front holes 307 and the rear holes 312.

Such joining between the front gear housing 301 and the rear gear housing 302 with the screws 315 facilitates subsequent mounting of the joined gear housing 3 to the body housing 2. The fixing with the screws 315 may be optional.

The countershaft 70 is accommodated in the front gear housing 301 with the axis extending in the front-rear direction. The countershaft 70 has a front end supported by a bearing 76, which is held in the front bearing holder 304, in a rotatable manner. The countershaft 70 has a rear end supported by a bearing 77, which is held in the rear bearing holder 314, in a rotatable manner. The countershaft 70 receives a bevel gear 78 on its middle portion in a manner rotatable together with the countershaft 70.

The bearing 31 supports the upper portion of the rotational shaft 18. The bearing 31 is received in the lower through-hole 305 in the front gear housing 301. The bearing 31 includes an outer ring and an inner ring with seals held between the rings. The seals are arranged vertically in the axial direction.

The front gear housing 301 has the lower portion protruding into the motor housing 9. The pinion 32 protrudes into the front gear housing 301 and meshes with the bevel gear 78. The countershaft 70 is integral with a first gear 79 received on its rear portion. O-rings are externally fitted on the bearing 31 supporting the pinion 32 and on the bearing 76 supporting the front end of the countershaft 70. The O-rings thus elastically hold the pinion 32 and the front end of the countershaft 70 in the front gear housing 301. This maintains appropriate meshing of the pinion 32 with the bevel gear 78.

The first spindle 71 is located above the countershaft 70 with its axis extending in the front-rear direction. The first spindle 71 has a rear end supported by a bearing 80, which is held in the rear bearing holder 313, in a rotatable manner. The first spindle 71 receives a second gear 81 on its rear portion in a manner rotatable together with the first spindle 71. The second gear 81 meshes with the first gear 79.

The clutch cam 72 is coupled to the second gear 81 with multiple balls 82 in a manner rotatable together with the second gear 81. The clutch cam 72 includes a rear cam 83 on its front surface.

The second spindle 74 is located in front of and coaxially with the first spindle 71. The second spindle 74 is held by a sleeve 84 in a manner rotatable and movable in the front-rear direction. The sleeve 84 is held in the upper through-hole 303 in the front gear housing 301 and in the casing 4.

The first spindle 71 has its front portion received in a blind hole 85 in a rear portion of the second spindle 74. The blind hole 85 receives a bearing 86. The front end of the first spindle 71 is loosely received through the bearing 86 and received in the blind hole 85 in a manner rotatable coaxially with the second spindle 74.

The coil spring 73 is externally mounted on the first spindle 71. The rear end of the coil spring 73 abuts against the front surface of the clutch cam 72. The front end of the coil spring 73 abuts against the rear surface of the bearing 86.

The second spindle 74 receives a flange 87 at its rear end. The flange 87 has a front cam 88 on its rear surface. The front cam 88 faces the rear cam 83 on the clutch cam 72. The front cam 88 and the rear cam 83 engage with each other in the forward and reverse rotational directions when in contact with each other.

The second spindle 74 is urged frontward by the coil spring 73. The sleeve 84 supports a stopper 89 at its rear end. The flange 87 on the second spindle 74 comes in contact with the stopper 89 to restrict the forward movement of the second spindle 74.

The second spindle 74 receives a bit holder 75 at its front end. The bit holder 75 can receive a bit or a tip tool such as a screwdriver bit in a detachable manner from the front.

The body housing 2 accommodates a push-drive assembly 90. The push-drive assembly 90 enables a push-drive mode. The push-drive assembly 90 includes a rod 91, a lever 92, and a sensor board 93.

The rod 91 is the shaft of the first spindle 71 and is independently of the first spindle 71. The rod 91 is movable in the front-rear direction. The rear end of the rod 91 protrudes through the rear gear housing 302 into the body housing 2.

The lever 92 is located behind the rear gear housing 302. The lever 92 is rotatably held by a lateral boss 94 protruding from the inner surface of the body housing 2. The lever 92 includes a pressing piece 95 and a detection piece 96. The pressing piece 95 protrudes downward behind the rod 91. The detection piece 96 protrudes upward behind the pressing piece 95. The detection piece 96 includes a magnet 97.

The sensor board 93 is located behind the detection piece 96. The sensor board 93 includes a magnetic sensor, such as a Hall element. The sensor board 93 can detect changes in the magnetic field of the magnet 97 resulting from rotation of the detection piece 96. The lever 92 is normally at a first rotational position indicated by the solid line in FIG. 4 under the urging force from a torsion spring 98. At the first rotational position, the detection piece 96 is in contact with the front surface of the sensor board 93.

The rod 91 is at an advanced position at which the rod 91 is pressed by the pressing piece 95 of the lever 92 at the first rotational position. The front end of the rod 91 at the advanced position is in contact with the inner bottom surface of the blind hole 85 in the second spindle 74 at the advanced position.

In the push-drive assembly 90, the rear end of the rod 91 presses the pressing piece 95 of the lever 92 backward in response to retraction of the rod 91. The lever 92 then rotates to a second rotational position indicated by the two-dot chain line. The detection piece 96 then rotates and separates forward from the sensor board 93. The sensor board 93 detects the change in the magnetic field resulting from the movement of the magnet 97 and outputs an on-signal.

The microcomputer in the control circuit board 54 receives operation signals from the switch 45, the forward-reverse lever switch for the forward-reverse switch lever 47, the sensor board 93, and the button switch 55. The microcomputer specifies the rotation direction of the motor 15 based on the signal from the forward-reverse lever switch and drives the motor 15. The microcomputer specifies an operational mode based on the operation signal from the button switch 55.

The feeder box 6 is urged by a coil spring 100 to an advanced position at which the feeder box 6 protrudes from the casing 4. The feeder box 6 receives collated screws (not shown) fed from the magazine 8 from below. The feeder box 6 includes a feeder 101. The feeder 101 feeds, by retracting against the urging force from the coil spring 100, one screw at a time to the position at which the bit tightens the screw.

The stopper base 7 is mounted on the feeder box 6 at the position adjustable relative to the feeder box 6 in the front-rear direction. The mounting position is adjustable in accordance with the length of the screw. The depth of the screw to be tightened can be set by an operation on a depth adjustment dial 102. The depth adjustment dial 102 is used to adjust the amount of protrusion of the bit from the stopper base 7.

For the screwdriver 1, depressing the button indicator 65 on the switch plate 60 moves the operation rod 62 downward to turn on the button switch 55. The microcomputer then switches the operational mode to a push-drive mode and turns on the LED 56. When turned on, the LED 56 emits light through the hollow rectangular prism 63 to the opening 63a to illuminate the illuminating portion 66. When the button indicator 65 is depressed again, the operation rod 62 is moved downward to turn off the button switch 55. The microcomputer then switches the operational mode to a normal mode and turns off the LED 56. This stops illuminating the illuminating portion 66.

An operator gripping the grip 11 with the right hand can depress the button indicator 65 on the switch plate 60 with the left hand. The switch plate 60 on the upper left surface of the battery mount 50 is easily operable.

In response to the operational mode being switched, the illuminating portion 66 starts or stops illuminating to allow the operational mode switching to be viewable. The illuminating portion 66 is located on the upper left surface of the battery mount 50 and in front of the grip 11. The illuminating portion 66 is thus not covered by the right hand gripping the grip 11. The operator can thus easily view the illuminating portion 66 either illuminating or not illuminating.

The operations in specific operational modes will now be described. The normal mode is first described.

A bit is attached to the bit holder 75 in the second spindle 74. The forward-reverse switch lever 47 is set to a forward-rotation position. The operator then grips the grip 11 and places the stopper base 7 onto the surface of a workpiece, such as a drywall. The operator then depresses the trigger 46. This turns on the switch 45, causing power to be supplied from the battery pack 51 to the motor 15 through the control circuit board 54. The rotor 17 thus rotates forward to transmit the rotation of the rotational shaft 18 through the pinion 32 to the countershaft 70. As the countershaft 70 rotates at a reduced speed, the first spindle 71 and the clutch cam 72 also rotate forward together with the countershaft 70. However, the second spindle 74 is at the advanced position, without the front cam 88 being engaged with the rear cam 83 on the clutch cam 72. Thus, the second spindle 74 does not rotate.

The operator then pushes the grip 11 to move the screwdriver 1 forward. In this state, the feeder box 6 retracts against the urging force from the coil spring 100. At the same time, the feeder 101 feeds, from the collated screws, one screw, which is placed in front of the bit. When the screw comes in contact with the workpiece, the second spindle 74, together with the bit, retracts against the urging force from the coil spring 73. The front cam 88 on the second spindle 74 then engages with the rear cam 83 to transmit the rotation of the clutch cam 72 to the second spindle 74. This rotates the bit forward with the second spindle 74, tightening the screw into the workpiece.

As the screw is tightened further, the screwdriver 1 moves forward. The stopper base 7 then comes in contact with the casing 4. After that, the second spindle 74 alone moves forward as the screw is tightened further. When the front cam 88 separates from the rear cam 83, the rotation is no longer transmitted to the second spindle 74 to complete the screw tightening. The operator then stops depressing the trigger 46 to turn off the switch 45. This stops the rotation of the rotor 17. When the bit separates from the screw, the feeder box 6 returns to the advanced position under the urging force from the coil spring 100. The second spindle 74 also returns to the advanced position under the urging force from the coil spring 73. Thus, when the operator pushes the grip 11 to move the screwdriver 1 forward, the next screw is fed and is tightened. This process is repeated for continuous tightening of screws.

Screwdrivers that can automatically feed screws in the manner described above are called autofeed screwdrivers. The autofeed screwdrivers may also be referred to as collated screwdrivers, collated screw guns, or autofeed screw guns.

In the push-drive mode, depressing the trigger 46 does not activate the motor 15. The stopper base 7 is pressed against a workpiece to move the screwdriver 1 forward. The feeder box 6 and the second spindle 74 then retract. The rod 91 in contact with the inner bottom surface of the blind hole 85 also retracts.

This causes the rear end of the rod 91 to come in contact with the pressing piece 95 of the lever 92, rotating the lever 92 to the second rotational position as described above. This causes the sensor board 93 to output an on-signal. In response to the on-signal, the microcomputer drives the motor 15. The front cam 88 then engages with the rear cam 83 to transmit the rotation of the clutch cam 72 to the second spindle 74. The bit rotates forward, together with the second spindle 74, to enable tightening of a screw.

In any operational mode, outside air is drawn in through the inlets 36 in the side surfaces of the body housing 2 as the fan 33 rotates with the rotation of the rotational shaft 18. The outside air drawn in through the inlets 36 flows through the first cooling channel 41 and then between the stator 16 and the rotor 17 and is discharged outside through the lower outlets 35. This cools the motor 15. A portion of the outside air undischarged through the lower outlets 35 flows through the second cooling channel 42 and then the slit 38 and is discharged outside through the intermediate outlets 37. This cools the bearing 31. Another portion of the outside air undischarged through the lower outlets 35 flows through the third cooling channel 43 and then the clearance 40 and is discharged through the upper outlets 39. This cools the gear housing 3.

The screwdriver 1 according to the present embodiment includes the motor 15 including the stator 16 and the rotor 17. The rotor 17 is rotatable relative to the stator 16 and includes the rotational shaft 18 (rotor shaft) extending upward frontward. The screwdriver 1 also includes the switch 45, the pinion 32, the clutch 5, and the bit holder 75. The switch 45 is operable to rotate the rotor 17. The pinion 32 is rotatable by the rotor shaft 18. The clutch 5 transmits rotation from the pinion 32. The bit holder 75 is located in front of the clutch 5 and is movable in the front-rear direction. The screwdriver 1 also includes the gear housing 3, the motor housing 9, and the grip 11. The gear housing 3 accommodates the pinion 32 and the clutch 5. The gear housing 3 includes the front gear housing 301 (partly) formed from metal. The motor housing 9 is joined to the gear housing 3 and accommodates the motor 15. The motor housing 9 is formed from resin. The grip 11 is joined to the motor housing 9 and accommodates the switch 45. The grip 11 is formed from resin. The bit holder 75 is movable to a rearward position to cause the clutch 5 to be connecting to transmit the rotation of the rotor 17. The bit holder 75 is movable to a frontward position to cause the clutch 5 to be disconnecting to transmit no rotation of the rotor 17.

The screwdriver 1 with the above structure has a shorter overall length in the front-rear direction and can be compact. The front gear housing 301 is formed from metal. This allows the pinion 32 and the bevel gear 78 to be positioned with predetermined accuracy. This improves the dimensional accuracy of the components and prevents gear noise.

The gear housing 3 holds the bearing 31 supporting the pinion 32. The front gear housing 301 includes the lower through-hole 305 formed from metal. The lower through-hole 305 holds the bearing 31. This structure allows stable meshing between the pinion 32 and the bevel gear 78 and thus effectively prevents gear noise.

The gear housing 3 includes two divided parts in the front-rear direction. This structure effectively prevents grease leakage.

The seal ring 310 (seal) is held between the front gear housing 301 (front part) and the rear gear housing 302 (rear part) being the two divided parts of the gear housing 3. Grease is thus less likely to leak between the front gear housing 301 and the rear gear housing 302.

The two divided parts of the gear housing 3 include the front gear housing 301 formed from metal and the rear gear housing 302 formed from resin. The gear housing 3 is thus lightweight.

The two divided parts of the gear housing 3 include the front gear housing 301 and the rear gear housing 302 fastened with the screws. This structure facilitates the mounting of the gear housing 3 to the body housing 2.

The motor housing 9 includes the pair of left and right half housings 2a and 2b. The lower portion of the gear housing 3 is held between the half housings 2a and 2b. This allows the gear housing 3 and the motor housing 9 to be a stably joined structure.

The motor 15 is accommodated in the motor housing 9 with the rotational shaft 18 extending diagonally upward frontward. This structure allows a space for installing the magazine 8 with the motor 15 facing upward.

The gear housing 3 is located above the motor housing 9. The pinion 32 on the upper end of the rotational shaft 18 protrudes into the gear housing 3. The gear housing 3 and the motor housing 9 thus overlap vertically, allowing the structure to be more compact in the front-rear direction.

The screwdriver 1 according to the present embodiment includes the motor 15 including the stator 16 and the rotor 17. The rotor 17 is rotatable relative to the stator 16 and includes the rotational shaft 18 extending upward frontward. The screwdriver 1 also includes the switch 45, the pinion 32, the clutch 5, and the bit holder 75. The switch 45 is operable to rotate the rotor 17. The pinion 32 is rotatable by the rotor shaft 18. The clutch 5 transmits rotation from the pinion 32. The bit holder 75 is located in front of the clutch 5 and is movable in the front-rear direction. The screwdriver 1 also includes the gear housing 3, the motor housing 9, and the grip 11. The gear housing 3 accommodates the pinion 32 and the clutch 5. The gear housing 3 includes two divided parts in the front-rear direction. The motor housing 9 is joined to the gear housing 3 and accommodates the motor 15. The grip 11 is joined to the motor housing 9 and accommodates the switch 45. The grip 11 is formed from resin. The bit holder 75 is movable to a rearward position to cause the clutch 5 to be connecting to transmit rotation of the rotor 17. The bit holder 75 is movable to a frontward position to cause the clutch 5 to be disconnecting to transmit no rotation of the rotor 17.

The screwdriver 1 with the above structure has a shorter overall length in the front-rear direction and can be compact. The gear housing 3 includes divided parts in the front-rear direction with improved sealing performance. This structure effectively prevents grease leakage.

Modifications will now be described.

The gear housing may include a front gear housing formed from resin and a rear gear housing formed from metal. The front gear housing and the rear gear housing may both be formed from metal. The front gear housing may include a portion (a portion including the lower through-hole in the embodiment) alone formed from metal. The portion receives the bearing that supports the pinion. For example, a metal ring for holding the bearing may be insert-molded into the remaining portion of the front gear housing. The front gear housing may be partly formed from metal or may have a portion including the upper through-hole and other portions formed from metal. The rear gear housing may also be partly formed from metal, or more specifically, the rear bearing holder may be formed from metal.

For the gear housing partly formed from metal, the gear housing may include two divided parts in the lateral or vertical direction, instead of the front-rear direction. In this structure as well, the metal components can reduce gear noise.

For the gear housing including two divided parts in the front-rear direction, the front and rear parts may both be formed from resin. This structure can also prevent grease leakage.

The gear housing may include multiple seals.

The motor may have the rotational shaft extending in any manner other than diagonally upward forward. The rotational shaft may extend upright vertically. In this case, the countershaft may also extend upright vertically to allow transmission of rotation to the clutch using, for example, a bevel gear.

The motor housing may have any structure other than the structure including left and right half housings. The motor housing may be an integral cylinder.

The grip may be shaped other than in a loop. The grip may be linear or L-shaped and protrude from the clutch.

The motor may be a motor other than a brushless motor.

The screwdriver may be used with any screws other than with collated screws.

### REFERENCE SIGNS LIST

1 autofeed screwdriver

2 body housing

3 gear housing

4 casing

5 clutch

9 motor housing

10 grip housing

11 grip

15 motor

18 rotational shaft

32 pinion

45 switch

50 battery mount

53 controller

54 control circuit board

70 countershaft

71 first spindle

72 clutch cam

73 coil spring

74 second spindle

75 bit holder

90 push-drive assembly

91 rod

92 lever

93 sensor board

301 front gear housing

302 rear gear housing

310 seal ring

What is claimed is:

1. A screwdriving tool, comprising:
a motor including a stator and a rotor, the rotor being rotatable relative to the stator and including a rotor shaft extending vertically;
a switch operable to rotate the rotor;
a pinion rotatable by the rotor shaft;
a clutch configured to transmit rotation from the pinion;
a bit holder located in front of the clutch, the bit holder being movable in a front-rear direction, the bit holder being at a rearward position to cause the clutch to be connecting to transmit the rotation of the rotor, the bit holder being at a frontward position to cause the clutch to be disconnecting to transmit no rotation of the rotor;
a gear housing accommodating the pinion and the clutch, the gear housing at least partly comprising metal;
a motor housing joined to the gear housing and accommodating the motor, the motor housing comprising resin; and
a grip joined to the motor housing and accommodating the switch, the grip comprising resin.

2. The screwdriving tool according to claim 1, wherein
the gear housing holds a bearing supporting the pinion, and
the gear housing includes at least a portion holding the bearing comprising metal.

3. The screwdriving tool according to claim 1, wherein
the gear housing includes two divided parts in the front-rear direction.

4. The screwdriving tool according to claim 3, further comprising:
a seal held between a front part and a rear part being the two divided parts of the gear housing.

5. The screwdriving tool according to claim 3, wherein
the two divided parts of the gear housing include a front part comprising metal and a rear part comprising resin.

6. The screwdriving tool according to claim 3, wherein
the two divided parts of the gear housing include a front part and a rear part fastened with a screw.

7. The screwdriving tool according to claim 1, wherein
the motor housing includes a pair of left and right half housings, and
the gear housing is at least partly held between the left and right half housings.

8. The screwdriving tool according to claim 1, wherein
the motor is accommodated in the motor housing with the rotor shaft extending diagonally upward frontward.

9. The screwdriving tool according to claim 8, wherein
the gear housing is located above the motor housing, and
the pinion on an upper end of the rotor shaft protrudes into the gear housing.

10. The screwdriving tool according to claim 1, further comprising:
a countershaft extending in the front-rear direction, the countershaft being configured to transmit rotation from the pinion,
wherein the countershaft transmits the rotation to the clutch, and
the countershaft is held in the gear housing.

11. The screwdriving tool according to claim 1, further comprising:
a countershaft extending vertically, the countershaft being configured to transmit the
rotation of the rotor shaft extending vertically,
wherein the rotor shaft and the countershaft are held in the gear housing.

12. A screwdriving tool, comprising:
a motor including a stator and a rotor, the rotor being rotatable relative to the stator and including a rotor shaft extending at least vertically;
a switch operable to rotate the rotor;
a pinion rotatable by the rotor shaft;
a clutch configured to transmit rotation from the pinion;
a bit holder located in front of the clutch, the bit holder being movable in a front-rear direction, the bit holder being at a rearward position to cause the clutch to be connecting to transmit rotation of the rotor, the bit holder being at a frontward position to cause the clutch to be disconnecting to transmit no rotation of the rotor;
a gear housing accommodating the pinion and the clutch, the gear housing including two divided parts in the front-rear direction;
a motor housing joined to the gear housing and accommodating the motor; and
a grip joined to the motor housing and accommodating the switch, the grip comprising resin.

13. The screwdriving tool according to claim 12, further comprising:
a seal held between a front part and a rear part being the two divided parts of the gear housing.

14. The screwdriving tool according to claim 12, wherein
the two divided parts of the gear housing include a front part comprising metal and a rear part comprising resin.

15. The screwdriving tool according to claim 12, wherein
the two divided parts of the gear housing include a front part and a rear part fastened with a screw.

16. The screwdriving tool according to claim 12, wherein
the motor housing includes a pair of left and right half housings, and
the gear housing is at least partly held between the left and right half housings.

17. The screwdriving tool according to claim 12, wherein
the motor is accommodated in the motor housing with the rotor shaft extending diagonally upward frontward.

18. The screwdriving tool according to claim 17, wherein
the gear housing is located above the motor housing, and
the pinion on an upper end of the rotor shaft protrudes into the gear housing.

19. The screwdriving tool according to claim 12, further comprising:
a countershaft extending in the front-rear direction, the countershaft being configured to transmit rotation from the pinion,
wherein the countershaft transmits the rotation to the clutch, and
the countershaft is held in a front part and a rear part being the two divided parts of the gear housing.

20. The screwdriving tool according to claim 2, wherein
the gear housing includes two divided parts in the front-rear direction.
